(19) United States
(12) Patent Application Publication
(10) Pub. No.: US 2010/0153279 A1
(43) Pub. Date: Jun. 17, 2010

(54) SYSTEMS AND METHODS FOR GLOBAL TRANSPORTATION,VETTING, AND PAYMENT

(76) Inventor: Walter Zahn, Somerville, MA (US)

Correspondence Address: BrockmanLeeLLC, P.O. Box 560146, West Medford, MA, 02156, US

(21) Appl. No.: 12/571,422

(22) Filed: Sep. 30, 2009

Related U.S. Application Data
(60) Provisional application No. 61/101,661, filed on Sep. 30, 2008.

(51) Int. Cl. G06Q 50/00; G06Q 30/00; G06Q 10/00; G06Q 20/00

(52) U.S. Cl. 705/80; 705/5; 705/6; 705/9

(57) ABSTRACT

Described are computer-based methods and apparatuses, including computer program products, for use and payment of global transportation and vetting systems and methods.

### RELATED APPLICATIONS

This application claims the benefit of priority to U.S. provisional application No. 61/101,661, filed Sep. 30, 2008. The entire teachings of which are incorporated herein in their entirety.

### FIELD OF THE INVENTION

The invention generally relates to ridesharing and use of public transport, particularly to systems and methods for global transportation, vetting, and payment.

### BACKGROUND

One reason people shy away from using ride share concepts is flexibility. There is an inherent safety net with driving one's own car, which allows a person to come and go as they please, and to leave without any time constraints or restrictions. Therefore, most ride share systems are geared towards organizing car pools or return trips where users have a fixed appointment for the ride back (e.g., the ride back home). On the other hand, public transport is not organized in this fashion. It generally decouples the trips to and from the destination. Users know that when they miss a bus or train, there is still another bus or train coming.

With the price of energy at its current levels, the commercial aspect of ride sharing is evident. For example, in Hamburg, Germany approximately one million people use public transport daily (as of 2008). Hamburg has nearly 1.8 million inhabitants. In comparison, the U.S. has approximately 49 billion public transport passenger miles. In Boston, Mass., there were 375 million rides (as of fiscal year 2007), where the population in the greater Boston area is approximately 4.5 million people. In July of 2008, some ride share systems had approximately 18,699 carpool listings (with 6,128 cross country travel listings), while another had over 2,000 carpool listings. U.S. Census Statistics in 2005 showed that 0.4 percent of Americans bike to work, compared with 2.5 percent who walk and 77 percent who drive alone.

There is a large unmet potential for rideshare users. Further, there is a large revenue potential for ride share services. For example, in 2004 the estimated passenger miles by rail and bus in the US was 47 billion miles.

### SUMMARY OF THE INVENTION

One aspect of the global transportation and vetting technology provided herein is a computerized method. In some embodiments, the method includes receiving one or more ride requests. The method further includes generating a transportation schedule based on the one or more ride requests, wherein for each passenger associated with each of the one or more ride requests, the transportation schedule comprises a pick-up location, a pick-up departure time, a drop-off location. In some embodiments, the transportation schedule includes route information. In some embodiments, the method further includes transmitting the transportation schedule to one or more transportation service providers. A bid is received from each of the one or more transportation service providers, and a transportation service provider is selected for the transportation schedule based on the bids.

Another aspect of the global transportation and vetting technology provided herein is a system. The system includes a communication manager configured to receive one or more ride requests, transmit the transportation schedule to one or more transportation service providers; and optionally to receive a bid from each of the one or more transportation service providers. The system further includes a server configured to generate the transportation schedule based on the one or more ride requests, wherein for each passenger associated with each of the one or more ride requests, the transportation schedule comprises a pick-up location, a pick-up departure time, a drop-off location, and route information. In some embodiments, the server is configured to select a transportation service provider for the transportation schedule based on the bids.

Another aspect to global transportation and vetting technology provided herein is a computerized method. The method includes vetting a member and storing vetted information in a subscriber database. In some embodiments, the method includes storing a trip detail, wherein the trip detail is based on a trip performed by a transportation provider. In some embodiments, cost is calculated based on the trip information. In some embodiments a payment is automatically transmitted for the cost. In some embodiments, cost is calculated automatically. Cost can be calculated based on a trip distance and/or a trip duration. Cost can be calculated by determining a load factor, wherein the load factor is based on a number of passengers associated with the trip.

Another aspect to global transportation and vetting technology provided herein is a system. The system includes a subscriber database. The system further includes a transaction component configured to vet a member, wherein vetted information is stored in the subscriber database. In some embodiments, the transaction component is configured to generate a trip detail, wherein the trip detail is based on a trip performed by a transportation provider, wherein the transportation provider is a public transportation system, a commercial transportation system, or a ride share transportation system. In some embodiments, the system includes an automatic fare calculator that is configured to calculate a cost based on the trip information. The system can also include an automatic funds manager configured to automatically transmit a payment for the cost.

Another aspect to global transportation and vetting technology provided herein is a computer program product. The computer program product is tangibly embodied in an information carrier. The computer program product includes instructions operable to cause a data processing apparatus to receive one or more ride requests and generate the transportation schedule based on the one or more ride requests, wherein for each passenger associated with each of the one or more ride requests, the transportation schedule comprises a pick-up location, a pick-up departure time, a drop-off location, and route information. In some embodiments, the computer program product includes instructions operable to cause a data processing apparatus to transmit the transportation schedule to one or more transportation service providers and to receive a bid from each of the one or more transportation service providers. In some embodiments, the computer program product includes instructions operable to cause a data processing apparatus to select a transportation service provider for the transportation schedule based on the bids.

Another aspect to global transportation and vetting technology provided herein is a computer program product. The computer program product is tangibly embodied in an information carrier. The computer program product includes instructions operable to cause a data processing apparatus to vet a member, wherein vetted information is stored in a subscriber database. In some embodiments, the computer program product further includes instructions operable to cause a data processing apparatus to store a trip detail, wherein the trip detail is based on a trip performed by a transportation provider, wherein the transportation provider is a public transportation system, a commercial transportation system, or a ride share transportation system. In some embodiments, a cost is calculated by the computer program product based on the trip information, and a payment is automatically transmitted for the cost.

Another aspect to global transportation and vetting technology provided herein is a system. The system includes a means for receiving one or more ride requests. The system further includes a means for generating the transportation schedule based on the one or more ride requests, wherein for each passenger associated with each of the one or more ride requests, the transportation schedule comprises a pick-up location, a pick-up departure time, a drop-off location, and route information. The system further includes a means for transmitting the transportation schedule to one or more transportation service providers. The system further includes a means for receiving a bid from each of the one or more transportation service providers, and a means for selecting a transportation service provider for the transportation schedule based on the bids.

Another aspect to global transportation and vetting technology provided herein is a system. The system includes a means for vetting a member, wherein vetted information is stored in a subscriber database. In some embodiments, the system includes a means for storing a trip detail, wherein the trip detail is based on a trip performed by a transportation provider, wherein the transportation provider is a public transportation system, a commercial transportation system, or a ride share transportation system. In some embodiments, the system includes a means for calculating a cost based on the trip information, and a means for automatically transmitting a payment for the cost.

In other examples, any of the aspects above can include one or more of the following features. The transportation provider can be a public transportation system, a commercial transportation system, or a ride share transportation system. The transportation schedule can be confirmed with each passenger associated with the one or more ride requests, and the transportation schedule can be confirmed with the transportation service provider for the transportation schedule. A best fitting bid can be automatically calculated for a transportation service provider from the one or more transportation service providers based on one or more bidding criteria. The bidding criteria can be one or more of price, rating, location, destination, type of transportation, and availability. One or more ride requests can be categorized.

In some examples, the server is a web server. A request database can be in communication with the server and configured to store the one or more ride requests, and a provider database can be in communication with the server and configured to store the one or more transportation service providers. An optimizer module can be in communication with the server and configured to categorize the one or more ride requests. The optimizer module can be configured to categorize the one or more ride requests based on one or more categorizing criteria.

In other examples, the categorizing criteria can be selected from the group consisting of pick-up location, drop-off location, the pick-up time, departure time, availability of a transportation service provider, price, and a rating of an available transportation service provider.

In some examples, a status of the member is verified in real time. Verifying comprises assessing one or more attributes of the member. The one or more attributes can be selected from the group consisting of account status, account standing, vetting status, account balance, and member rating. The member rating can be an automatic member rating. The member rating can be automatically calculated based on a number of trips, a ratio of complaints, or both.

In other embodiments, the trip detail comprises a transaction code. The trip detail can further comprise a driver membership number, a passenger membership number, and leg information for each leg of one or more legs of the trip. The leg information can comprise a load factor, a location information, a time information, and a distance information. In some embodiments, the location information comprises a start point and an end point, and the time information comprises a start time and an end time.

In some embodiments, for a member account, either an auto-recharge is performed for the member account, or an auto-discharge is performed for the member account, or both.

In other embodiments, a membership card is provided. The membership card can be configured to provide the member access to the system. The membership card can comprise a color, a photograph, a date, an RFID component, a magnetic strip, a member level, or any combination thereof. The transaction component can be further configured to provide one or more additional cards for a member. In some embodiments, an automatic insurance manager is provided. The automatic insurance manager can be configured to provide insurance for the member.

The global transportation and vetting technology described herein can provide one or more of the following advantages. An advantage is the system opens ride sharing to a much wider community by offering reasonable fall back options (e.g., a no-rider-left-behind pact). A Ride-sharing portal that can make use of the system has a competitive advantage in the market. A member can benefit financially when ride sharing into work and back. A member can further benefit when entering public transport systems worldwide, as the member does not need to figure out the fare systems before riding (single ride, day ticket, zones, student, etc.). A member's company can benefit by having to subsidize less employee parking due to an efficient and reliable ride share system. A member's company can further benefit because it needs much less time when dealing with employees' expenses. The public transport systems can benefit, as they need to maintain less ticket vending points. Passengers have no chance any more to cheat the system as riders pass entrance and exit swipe points. Drivers of the system benefit financially. Using the system avoids city parking space providers, car companies (less total mileage due to higher average load factor), and excessive gas usage. Employers can benefit from simplified travel expense management through dedicated employee travel member accounts.

The various embodiments described herein can be complimentary and can be combined or used together in a manner understood by the skilled person in view of the teachings contained herein. Other aspects and advantages of the technology provided herein will become apparent from the following detailed description, taken in conjunction with the accompanying drawings, illustrating the principles of the technology by way of example only.

### BRIEF DESCRIPTION OF THE DRAWINGS

The foregoing and other objects, features, and advantages of the technology provided herein will be more fully understood from the following description of various embodiments, when read together with the accompanying drawings.

FIG. 1 depicts an exemplary flowchart illustrating public transport global transportation vetting and payment;

FIG. 2 depicts an exemplary flow chart illustrating a metro entry procedure;

FIG. 3 depicts an exemplary flow chart illustrating a metro exit procedure;

FIG. 4 depicts an exemplary flow chart illustrating a hitch-hike start process;

FIG. 5 depicts an exemplary flow chart illustrating a hitch-hike end process; and

FIG. 6 depicts an exemplary flow chart illustrating a ride request fulfillment optimizer.

### DETAILED DESCRIPTION

In general overview, systems and methods are provided for a global transportation system. A Global Transportation Vetting and Payment System (GTVPS) acts as a global clearing house service for paid trips. GTVPS provides a membership based system where a user's account can be used to pay for global transportation services, ranging from public transport to air transportation. A Ride Request Fulfillment Optimizer (RRFO) extends a public transport concept to ride share systems so that the ride share systems can operate in a one-way approach.

### Global Transportation Vetting and Payment System

GTVPS acts as a global clearing house service for paid trips of a transportation system. Each user establishes one or more accounts, and the system transfers amounts between GTVPS accounts of users and providers of transportation. Advantageously, GTVPS makes ride sharing safe and convenient (e.g., through membership background checks), creating an option for people transport. For example, GTVPS allows people to be willing to offer a ride to a ‘stranger’ when they know the ‘stranger’ is not a criminal since they have been vetted through the membership process. The GTVPS system allows the provider to receive a cashless payment for their services, which is computed automatically and without hassle.

The system can operate as a universal payment method for both public and private transport systems. GTVPS provides standards and methods to regulate and organize an otherwise standardless system. GTVPS can create significant savings potential for public transport providers. For example, the system can automate tasks that previously required human intervention (e.g., train conductors would be no longer required to make sure passengers have a valid ticket). From a passenger perspective, users no longer need to buy individual tickets or proprietary passes, saving both time and money. The transport system operates with one card worldwide and applies a user's fare automatically.

A user can be assigned one or more membership cards. An active GTVPS membership card can be used to ‘pay’ for any type of transportation service, whether the service is public or private. For example, a membership card can be used to pay for the use of public transport worldwide, the use of commercial transport worldwide (e.g., taxi, limo services, and flights), the use of toll roads worldwide, and/or shared rides worldwide (e.g., organized car pools, organized ride sharing, and spontaneous ‘hitch hiking”) In some embodiments, the drivers and passengers are GTVPS members. In some embodiments, the use of public transportation, the use of commercial transport worldwide, and the use of toll roads worldwide can be paid if the services are GTVPS partners.

GTVPS can be much more than a simple payment card. For ride share users, it can involve vetting of a user and can offer insurance options through membership. In some embodiments, GTVPS logs trip information (e.g., who, when, from where, to where). This can allow for safe and convenient use of ride sharing offers. In some embodiments, GVPTS offers automatic fare calculation based, for example, on distance between start and end of trip and/or many other parameters. In some embodiments, GTVPS can also offer family and company cards to be set up via linked accounts. Especially with company cards GTVPS can dramatically simplify travel expense clearing.

The GTVPS system can provide for many different commercial applications. In some embodiments, one commercial application of GTVPS is public transport. All public transport systems worldwide can make use of this system. Because GVPTS is a universal system, public transport systems using GVPTS will not need to migrate from a cash based system to a proprietary cashless system. In addition, GTVPS can coexist with a proprietary cashless system, and, therefore, does not need to substitute for a proprietary solution, if, for example, one is already in place in the public transport system. In some embodiments, proprietary solutions can be phased out over time. GTVPS can also be a system integrator. If for example, a regional provider (e.g. suburban bus services) joins an urban transportation network, GTVPS can be used to harmonize fares. Furthermore, where passengers have access to more than one public transport system that participates in GVPTS, the passengers can seamlessly use their membership to pay for transport using the different public transport systems.

In some embodiments, another commercial application of GTVPS is ride share systems. Ride share providers can subscribe to GTVPS. The system provided herein allows ride share providers and users to operate in a cashless system. In addition, in some embodiments, GTVPS vets each member. In some embodiments, GTVPS offers insurance options to the member. For example, a GTVPS membership can include insurance that will guarantee a backup ride if the ride share provider does not provide the ride.

In some embodiments, another commercial application of GTVPS is car pooling, where car pools can make use of GTVPS. GTVPS can operate on a ride-by-ride basis. Therefore, in car pool members do not have to track any data regarding car pool participation (e.g., who was a driver, how often an individual drove the car pool, and how many people were on board) to calculate each member's share for participating in the car pool.

In some embodiments, another commercial application of GTVPS is a spontaneous ‘Hitch-Hike’ Mode. GTVPS can enable and facilitate a safe way of hitch-hiking. In some embodiments, members (drivers and riders) are vetted. In some embodiments, each trip is logged. The driver can be paid for the ride in a cashless, automatic system. For example, if a member needs a ride home and flashes his or her membership card to passing vehicles, a driver can recognize their association with the system and spontaneously offer a ride to the member. For example, a member can wave their membership card to solicit a ride from another member.

In some embodiments, another commercial application of GTVPS is extension to commercial transport providers (e.g., companies that offer taxi, van, limo, and air transport services). GTVPS can also include add-on services. For example, there is a marketing opportunity because the system can reach public transport users worldwide through a membership, representing a large marketing potential. Another add-on service can be insurance, where in some embodiments insurance on certain types of rides is offered to members.

A GTVPS system can generate revenue by charging users for various services. These services can include, for example, vetting of applicants as ride share members (e.g., criminal background checks and driving record checks), computing and processing the fee for completed trip (e.g., to be shared between parties), auto-recharge of a member's account, auto-discharge of payments from a member's account, and provisioning account statements for printing. The services can be assigned separate fees that can be included in the GTVPS membership fee.

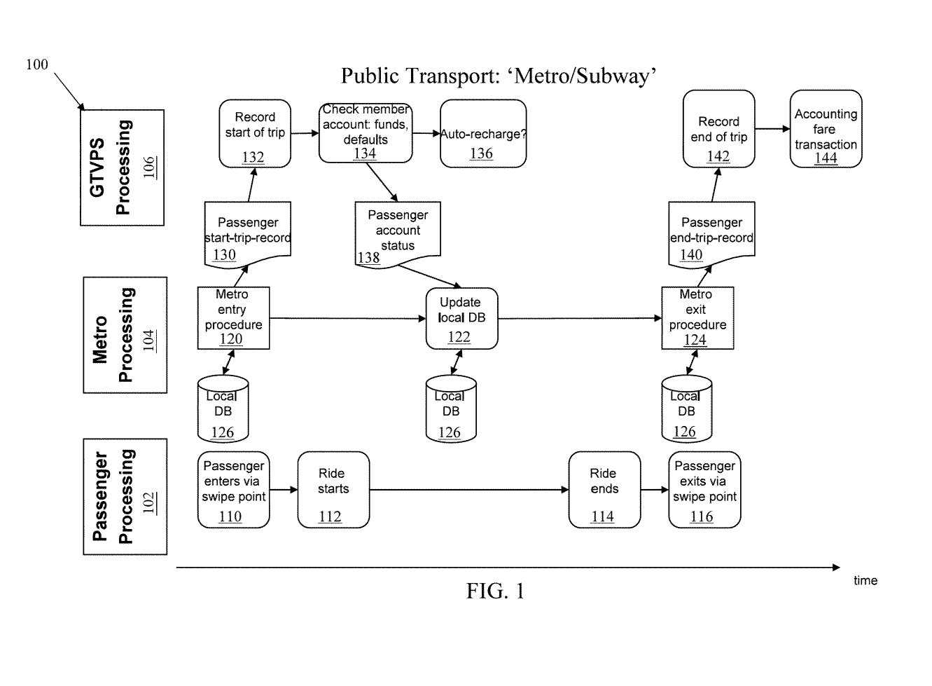

FIG. 1 depicts an exemplary flowchart illustrating public transport global transportation vetting and payment process 100 as executed on a computer system in some embodiments. The process 100 includes passenger processing 102, metro processing 104, and GTVPS processing 106. For passenger processing 102, a passenger enters 110 through a swipe point (e.g., the passenger swipes his or her membership card at a turnstile), the ride starts 112, the ride ends 114, and the passenger exits through a second swipe point. For example, a member riding the commuter rail enters the train by swiping their membership card, and once the train reaches their stop, they exit by swiping their card again to indicate when their trip is completed. The ride start 112 and ride end 114 times can be used to calculate a passenger's fare, determine which portion of the GTVPS system the passenger is using, and any other trip related information.

Metro processing 104 includes performing 120 a metro entry procedure, updating 122 a local database, and performing 124 a metro exit procedure. A local database 126 is used to store information related to the GTVPS process. GTVPS processing 106 includes generating 130 a passenger start-trip-record, recording 132 the start of the trip, checking 134 the member account (e.g., funds, defaults), checking 136 whether to auto-recharge, and determining 138 a passenger account status. For example, when a passenger enters 110 via a swipe point, the system generates 130 a passenger start-trip-record for the particular trip the passenger is undertaking. In some embodiments, each trip has a unique trip record. The member account is checked 134 for each trip to determine 138 the passenger's account status. For example, if the passenger has insufficient funds in the account to undertake a trip, the system auto-recharges 136 the passenger's account. For example, an auto-recharge can debit a member's funds from a checking account or other credit card and deposit the amount into the passenger's account to provide sufficient funds for the particular trip. If, for example, the member has multiple defaults, an alarm can be raised in the system.

Metro processing 104 includes generating a passenger end-trip-record, recording 142 the end of the trip, and accounting 144 for the fare transaction. For example, when a member completes 114 their ride and exits 116 via the swipe point, the passenger end-trip-record is generated 140 to indicate the end of the trip. By recording 142 the end of the trip, the total trip cost can be calculated and debited from the user's account. The total trip cost can be calculated, for example, based on a trip time, trip distance, a number of stops, a flat fare, or any other metric.

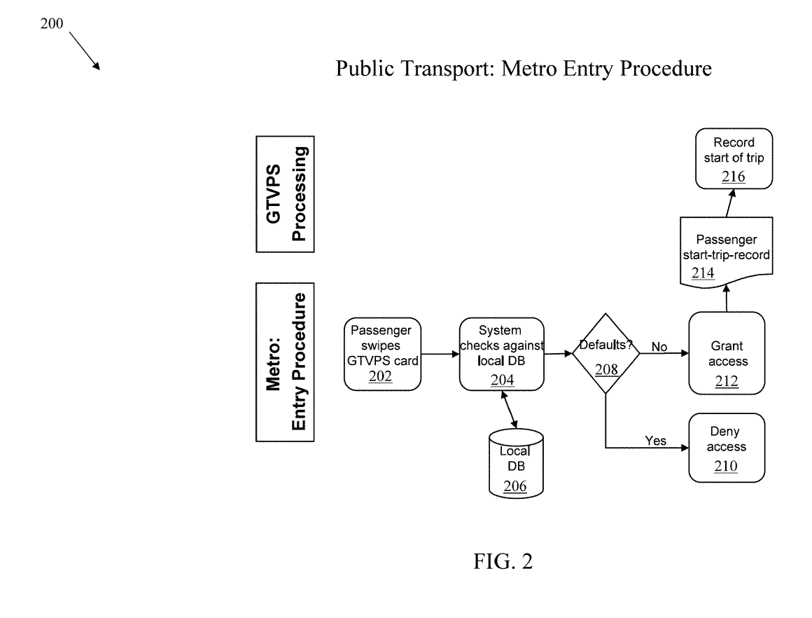

FIG. 2 depicts an exemplary flow chart illustrating a metro entry procedure 200 as executed on a computer system in some embodiments. The metro entry procedure 200 includes the passenger swiping 202 a GTVPS membership card. The system checks 204 the local database 206. For example, the system checks the local database to verify the passenger's account. The system checks 208 if the passenger has any defaults. If the passenger has defaults, the system denies 210 the user access. If the passenger does not have any defaults, the passenger is granted access 212. The system generates 214 a passenger start-trip-record. The system records 216 the start time of the trip. For example, if a user has one or more unpaid trips, the system will not allow the user to make any additional trips until the defaults are cured.

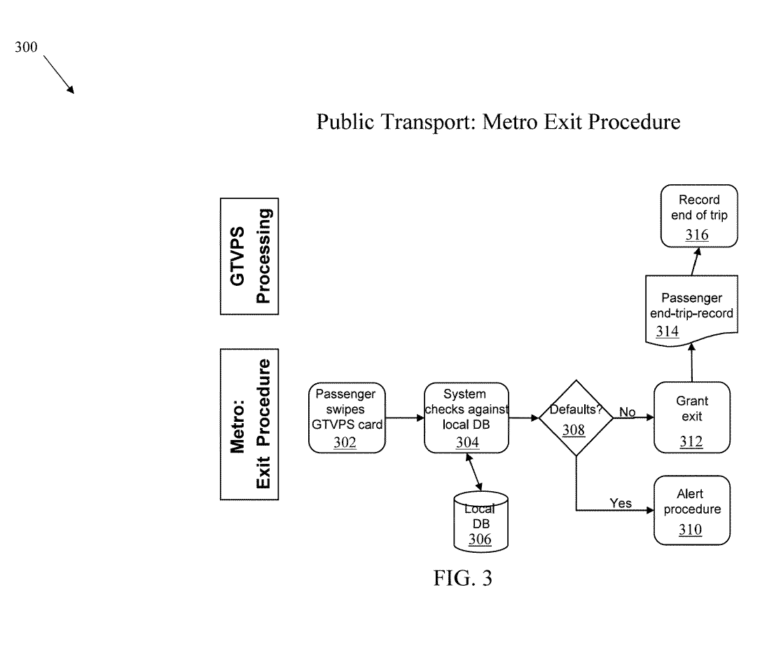

FIG. 3 depicts an exemplary flow chart illustrating a metro exit procedure 300 as executed on a computer system in some embodiments. A passenger swipes 302 a GTVPS card at the end of the trip. The system checks 304 the passenger against the local database 306. If the passenger has defaults 308, the system undertakes 310 an alert procedure. For example, if a passenger has insufficient funds to pay for the trip in their account, the user is not allowed to exit from the boarding terminal. In some embodiments, the passenger can recharge their membership card, cure the current and any previous defaults, pay cash for the trip, or undertake any other payment option to pay for the trip. If the user does not have any defaults, the user is granted 312 exit. The passenger end-trip-record is generated 314 and stored. The end of the trip is recorded 316 for the trip record.

In some embodiments, a passenger's account can be checked for a maximum payment amount to prevent any defaults once the trip is completed. For example, if the maximum charge for riding a metro is $15.00 (i.e., traveling to the furthest stop from the passenger's current location), the user's account can be validated for a charge of $15.00. If the passenger gets off at an earlier stop and the charge is less than $15.00, the passenger's account is only debited the amount of the trip. Advantageously, the passenger is only allowed to enter the transportation system if their account has valid funds to complete any trip. In some embodiments, it is undesirable to prevent a passenger from entering a transportation system unless they have a maximum fee. For example, if the passenger only travels one stop to get home, the passenger does not need to have the maximum charge in their account. In some embodiments, if a default is detected, the passenger's account is auto-recharged to pay for the needed amount.

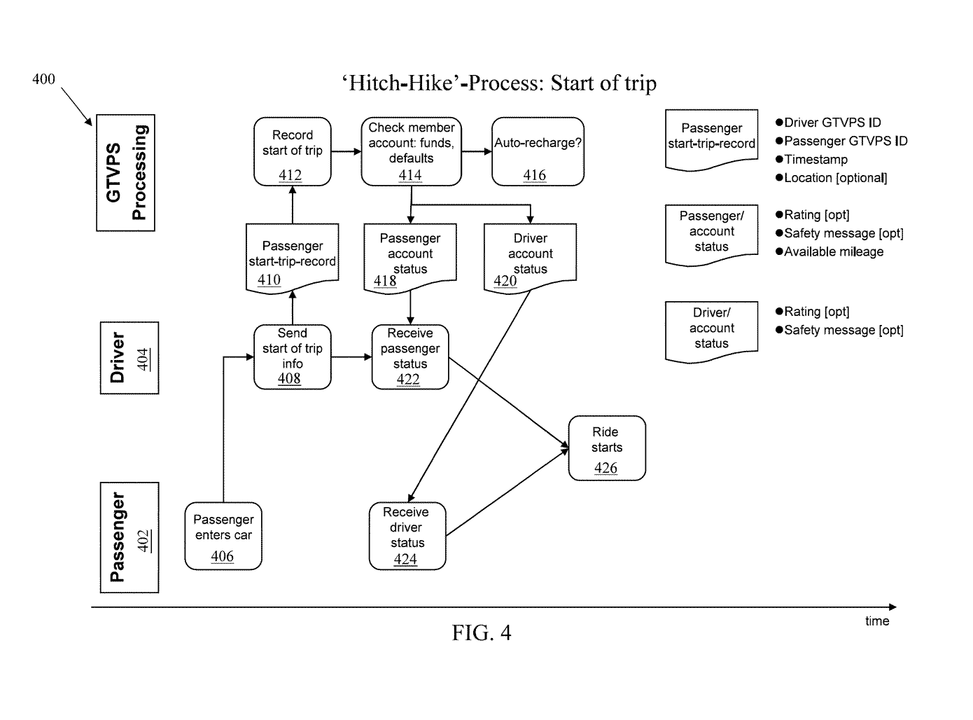

FIG. 4 depicts an exemplary flow chart illustrating a hitch-hike start process 400 as executed on a computer system in some embodiments. A hitch-hike includes a passenger 402 and a driver 404. The passenger 402 initiates the process by entering 406 the driver's 404 car. Start of trip information is generated 408 by the system. The passenger start-trip-record is generated 410 for the particular trip. The start of the trip is recorded 412. The passenger account is checked 414 by the system. For example, the passenger account is checked to verify the member has sufficient funds and there are no unresolved defaults on the member's account. If the passenger's account has insufficient funds, an auto-recharge is performed 416 to replenish the user's account. A passenger account status is generated 418. A driver account status is generated 420. The passenger account status is received 422 by the driver. The driver account status is received 424 by the passenger 402. For example, the driver's account is verified to indicate a safe driver record. The ride starts 426 after completion of the driver account status and the passenger account status.

The passenger start-trip-record can include, for example, a driver GTVPS ID, a passenger GTVPS ID, a timestamp, and an optional location. For example, each member of the TVPS system can be assigned a unique user identification number. Each start-trip-record associated with that member can include the member's unique ID. The passenger account status check can verify an optional rating of the driver, display an optional safety message, and check available mileage the passenger 402 has sufficient stored funds to pay. For example, as a passenger continues to use the system, they cumulatively accrue points towards their member rating. A member rating can be decreased, for example, when the member has defaults. The check of the driver account status can include checking an optional rating and an optional safety message. The safety message can include safety information relevant to anything that happened since the last vetting of the member, which is stored as a safety message on the member account. In some examples, a member is vetted every six months or every twelve months. For example, if the member is held at fault for an accident such as a drunk driving accident, the member can be terminated but may still try to use their membership card. This information can be put into the safety message so the individual can no longer use their membership card.

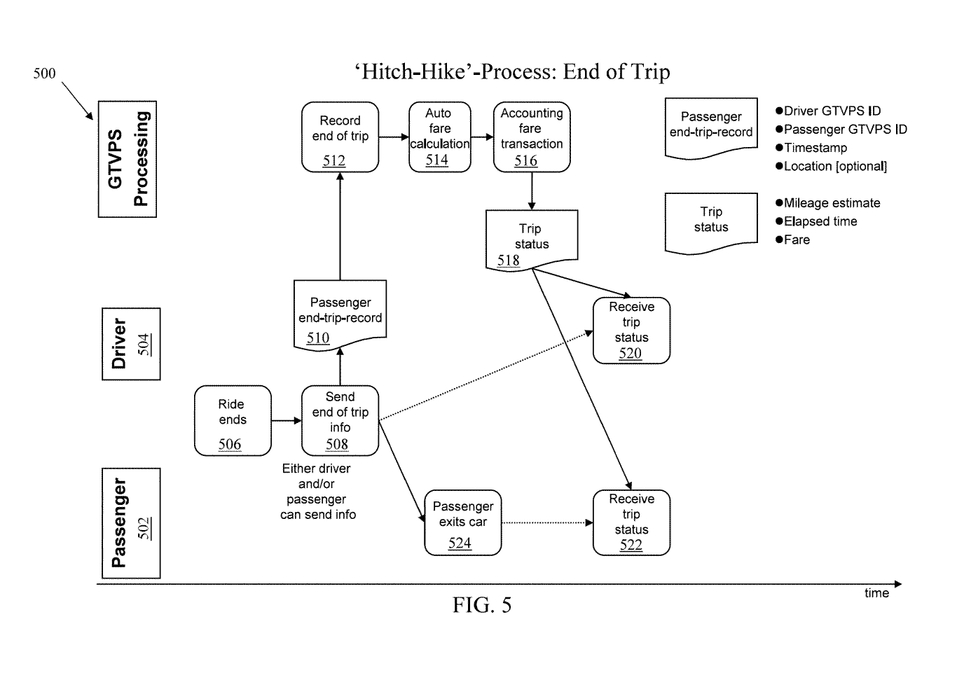

FIG. 5 depicts an exemplary flow chart illustrating a hitch-hike end process 500 as executed on a computer system in some embodiments. The passenger 502 and driver 504 end the process when the ride ends 506. Upon completion of the trip, the end of trip information is sent 508 by either the driver and/or the passenger. The passenger end-trip-record is generated 510. The system records 512 the end of the trip. The fare is automatically calculated 514 for the trip. The fare is accounted 516 for from the user's account. A trip status 518 is generated to show the trip is completed. The trip status is received 520 by the driver 504. The trip status is received 522 by the passenger 502 after the passenger exits 524 the car. The passenger end-trip record can include a driver GTVPS ID, a passenger GTVPS ID, a timestamp, and an optional location. The trip status can include a mileage estimate, an elapsed time, and a fare. For example, the mileage can be estimated using a GPS. An elapsed time can be stored between the trip start time and the trip end time. The fare can be calculated, for example, based on an estimated mileage and/or based on the trip duration. For example, the driver can estimate he or she travels at an average of twenty miles per hour, and if the trip took a half hour, the fare is based on an estimated ten miles.

In some embodiments, the membership database stores information pertaining to member accounts, trip information, and other relevant information of the system. The membership database can store a membership level. For example, a membership level can be anonymous public transport, named public transport, ride share, and temporary ride share driver. Anonymous public transport can include a member ID, payment information (e.g., credit card credentials, a validated bank account, or a validated check account), a threshold amount for auto recharge, an amount for auto recharge, and a membership type assigned to anonymous public transport. For example, a member can have a credit card on file so when their account balance is debited below $20.00, the member's account is automatically recharged and additional $20.00 from the member's credit card.

Named public transport can include a member ID, payment information, a threshold amount for auto recharge, an amount for auto recharge, and a membership type (e.g., where the membership type is assigned to “named public transport”). Additionally the named public transport includes a member ID and on online password for access to a web-based interface, the member's name, address, an email address, and linked account information. The linked account information can be, for example, linked family or company member cards.

Ride share can include a member ID, payment information, a threshold amount for auto recharge, an amount for auto recharge, and a membership type (i.e., where the membership type is assigned to “ride share”). Additionally, ride share can include an online member ID and on online password, the member's name, address, an email address, and linked account information. Ride share additionally can include a social security number, a phone number, a member type, a gender, insurance information, an auto discharge threshold, an auto discharge amount, a photograph, a license plate number an a driver license number, and the like. An auto discharge threshold and amount can be used to keep the account from reaching to large of an amount for drivers. For example, once the account reaches over $100, a $50 increment can be transferred to the member's savings account. The license plate and driver's license number can be omitted for a passenger.

Temporary ride share driver can include a name, a phone number, a driver's license number, and a license plate. A temporary ride share driver is used when a non-GTVPS driver offers a ride to a GTVPS hitch hiker. Because the non-GTVPS driver does not have an established account, sufficient information is collected to keep an accurate record of the transaction. Table 1 below summarizes the exemplary membership levels and relevant information. Table 1 represents only an example of various membership levels. Other membership levels and membership criteria can be used without departing form the spirit of the system. Additional membership levels can be contemplated based on the scope of the GTVPS application:

TABLE 1

| Membership | level Included | Info Remark |
|---|---|---|
| Anonymous public transport | Member ID | Optional |
| Anonymous public transport | Payment info such as credit card | Recommended to have |
| | credentials | |
| Anonymous public transport | Threshold for auto recharge, recharge | Recommended to have |
| | amount | |
| Anonymous public transport | Member type = anonymous public | |
| | transport | |
| Named public transport | All other fields from anonymous | |
| | public transport | |
| Named public transport | Member ID, online password | |
| Named public transport | Name | |
| Named public transport | Address | |
| Named public transport | Email address | |
| Named public transport | Member type = named public transport | |
| Named public transport | Linked account information | e.g. for family or company cards |
| Ride share | All fields from named public transport | |
| Ride share | Social security number [US] | |
| Ride share | Phone numbers | |
| Ride share | Member type, multiple options | |
| | possible: pilot, driver, passenger | |
| Ride share | Gender | |
| Ride share | Insurance options | |
| Ride share | Auto discharge threshold and amount | Relevant for non-passenger |
| Ride share | Photograph as required for passport in | |
| | country of residency | |
| Ride share | License plate | Relevant for drive |
| Ride share | Driver license number | Relevant for driver |
| Temporary ride share driver | Name | Scenario: Non GTVPS driver offers |
| | | ride to QTVPS hitch hiker. |
| Temporary ride share driver | Phone numbers | |
| Temporary ride share driver | Driver license number | |
| Temporary ride share driver | License plate | |

The system can include a member database user interface. Users can create and maintain a membership account online via a web browser. Other features offered can include viewing and printing a member's account activity. The system can include a transaction interface. For example, the system can include a mass transport interface. The mass transport interface can be used by subscribing partners to interface transaction data electronically. The mass transport interface can be used by third parties to create anonymous public transport user accounts. Ride share transactions can be entered via the web interface (e.g. from smart phone applications or from a users home computer).

The system can include a phone interface. The phone interface can be used for ride share transactions. Transactions can be entered via the phone interface using, for example, keyed input and/or speech recognition (e.g., auto recording and/or operator recording) or SMS.

In some embodiments, the GTVPS system includes an automatic fare calculator. Subscribers can make use of an automatic fare calculator within GTVPS. For automatic fare calculation, GTVPS can offer a wide variety of solutions to subscribers. Some exemplary approaches to subscribers can include any combination of the following: distance based fares, distance and load factor based fares, time based fares, and time and load factor based fares. For distance based fares (e.g., per country), GTVPS calculates the distance between start and end of trip using geographic information provided from transaction and multiplies with price per distance unit.

For distance and load factor based fares (e.g., per country), the fares can be calculated per leg with same load factor. GTVPS calculates the distance between start and end of trip using geographic information provided from transaction, multiplies with price per distance unit and multiplies with load factor. For time based fares (e.g., per country), GTVPS calculates the distance between the start and end of the trip using elapsed time and multiplying with average speed and multiplies with price per distance unit. For time and load factor based fares (per country), fares can be calculated per leg with the same load factor. GTVPS calculates the distance between start and end of trip using elapsed time and multiplying with average speed and multiplies with price per distance unit.

Distance can be calculated based on geographic information. The distance between start point and end point can be calculated via driving directions solution (e.g. Google maps) as the driving distance between two geographical points can be substantially longer as their geographical distance. Price can be calculated per distance unit. This can be calculated, for example, per means of transport (e.g., car, airplane, boat). GTVPS can use official figures for per distance price. Price per distance unit can be posted on GTVPS's website. In some embodiments, subscribers agree to the use of this price per distance unit when signing up. For example, in the US, the rate used by the IRS for the use of a car is 48.5 cents/mile (in 2008). With a load factor of 1 (equals one passenger), the price per distance unit would be 24.25 cents/mile.

The load factor can be calculated per means of transport (e.g., car airplane, boat). In some embodiments, car load factor is calculated. Car load factor can be calculated for example as 1/n where n is equal to the number of posted passengers plus the driver, such that, with 1 passenger the load factor is 0.50, with 2 passengers the load factor is 0.33, and with 3 passengers the load factor is 0.25.

The average speed can be calculated per means of transport (e.g., car, airplane, boat) and country. For example, in some embodiments, GTVPS can use official figures for average speed calculation. Average speed can be posted on GTVPS's website. In some embodiments, GTVPS can use historic GTVPS transaction data to calculate actual average speed from subscribers who provide geographical information with their transactions.

The system can include an automatic funds manager. In some embodiments, GTVPS membership is configured to automatically maintain minimum and maximum funds on each member's account to make sure that services can be paid for. Below are some exemplary services of the automatic funds manager. The exemplary services can be used in any combination.

An auto-recharge service operates where each member can set a threshold for auto-recharge initiation and an amount to be automatically recharged. Recharging can be done, for example, via credit card, debit card, bank account debit and other country specific means. Auto-discharge (e.g., for drivers and 3rd party service providers) can be configure so each member can set a threshold for auto-discharge initiation and an amount to be automatically discharged. Discharging can be done, for example via credit card, debit card, bank account deposit, bank check and other country specific means.

In some embodiments, an auto-credit-card-reservation service is provided. To obtain and maintain a certain membership status (e.g. Bronze/Silver/Gold) a recurring credit card reservation might be required to reserve funds on the member's credit card. This option is useful, for example for members who use GTVPS for long distance traveling (by car, train, plane etc.)

In some embodiments, a member rating is assessed. This component can apply, for example, to non public transport transactions. In some embodiments, member rating takes into account the recent history (e.g. 12 months), called the rating relevant timeframe. Member rating can include characters. For example, one character represents the number of trips taken in the recent member rating relevant timeframe (e.g., ‘A’ is the highest rating, ‘C’ is the lowest, ‘_’ no trips yet). A second character can represent the ratio of complaints in the recent member rating relevant timeframe. (e.g., ‘A’ is the best rating (lowest ratio of complaints), ‘C’ is the worst rating for highest ratio of complaints). Complaints about a member can be filed via web interface or phone interface.

In some embodiments, membership can include an automatic insurance manager. This component can apply, for example, to non public transport transactions. If a member has subscribed to an insurance option to be applied to shared rides as passenger, GTVPS can document and communicate to the relevant insurance partner each ride taken. GTVPS can also automatically handle transfer of funds (from passenger GTVSP account to insurance GTVPS account) and eventually auto-discharge to insurance.

In some embodiments, the system includes a GTVPS phone system. Incoming number identification can, for example, identify an incoming number, look up related member, and/or ask caller for confirmation of member-ID. After confirmation, the system can, for example, offer handling of open transactions or handling of new transactions.

In some embodiments, the system can perform a location determination on a member cell phone. If the member's cell phone is GPS enabled, this would allow the use of location information throughout the transactions. Some cell phone service providers offer a location determination via software without the use of a GPS device.

In some embodiments, an application on a smart phone can facilitate the transactions. For example, Google's new operating system ‘Android’ for mobile phones provides an excellent basis to develop the mobile piece for GTVPS. For example, ‘Android’ is set up for public use and a SDK can be downloaded.

In some embodiments, the GTVPS Member card is an RFID card that can be read when entering public transport or transport provided by private service providers. RFID card readers will soon become inexpensive, which means, for example, that a driver could install one in the car or on cell/smart phone. The card should display, for example, a membership level, card validity, and photo of the member.

In some embodiments, a back-end computing system is provided to use of state-of-the-art environment. For example, the back-end computing system can use cloud computing. The back-end computing system can offer a high level of security against outside attacks.

In general overview, GTVPS can be a membership based system. The system can be a combination of the following 2 levels, for example, an unvetted public transport level and a vetted ride share level. Membership card can be geared towards setting a global standard for quick access verification. For example, at the public transport level the system can include an RFID card, a magnetic strip, and/or a card number. For example, at the ride share level, the membership card is like the public transport level plus photograph and member status. There are account linkability options such as options for family and company cards. Visibility can create demand. Colors are important. To ‘hike’ a ride, members may “flash” their colored membership card to signal their demand.

Real time membership status verification per means of transport may be used to, for example, determine if a membership account is still active, whether the membership account is in good standing, if the vetting status is good, to calculate the remaining distance based on an auto-fare calculation and load factor 1, and to verify a member rating. The system can provide a cashless payment system can be implemented. The system can include member accounts with auto-recharge and auto-discharge settings, and fares can be transferred between GTVPS accounts. The system provides for an automatic fare calculation option.

In some embodiments, trip detail can be recorded for public transport. For example, per trip the system can assign a transaction code (e.g., format <x . . . x>+<_>+<yyy> with y=country phone code and x=unique alphanumerical code per <yyy>) and a time frame. The code can be guaranteed to be unique per time frame (e.g. within one week beginning Sunday 00:00 am and ending Saturday at 23:59:59 pm Greenwich time).

In some embodiments, trip detail can be recorded for ride sharing. For example, per trip the system can assign a transaction code (e.g., format <x . . . x>+<_>+<yyy> with y=country phone code and x=unique alphanumerical code per <yyy>) and time frame. The code can be guaranteed to be unique per time frame (e.g., within one week beginning Sunday 00:00 am and ending Saturday at 23:59:59 pm Greenwich time). The system can provide for a driver GTVPS membership number and/or a passenger GTVPS membership number. For each leg (e.g., when another passenger joins or leaves) of trip, the system can record load factor, start point (if available), end point (if available), start time, end time, calculated distance, and calculated fare. Member rating can be used for non public transport use. For example, a member rating may be represented by 2 characters based on recent member rating relevant timeframe, where one character representing the number of trips taken (e.g., class), and a second character represents the ratio of complaints.

Exemplary system components of an embodiment can include a website, a member database (e.g., a database with a web front-end), an auto fare calculator, an auto funds manager, a member rating, a transaction interface (e.g., for all transactions), preparation for internationalization, and a smart phone application (e.g., using Android) or iphone. The technology and infrastructure can include servers, desktops, laptops, variety of software, firmware, and other relevant technology. The system can utilize a SW development environment.

For exemplary uses, for example, public transport in Boston in 2007 is an estimated 375 million rides, where the population in the greater Boston area is approximately 4.5 million people. For example, for public transport in the US in 2005, there were approximately 49 billion unlinked trips.

Because of the potential use of membership rules (e.g., criminal background check, member rating, etc.) services can be used from, for example, credit card or bank institutions, rental car companies, and/or insurance companies. The system can support a temporary driver only membership. For example, a temporary membership status might help increase the membership base (e.g. drivers who have seen people with GTVPS membership cards and who would like to offer a ride to someone). Such a temporary membership would at least offer some additional security for passenger as ride is documented with driver details.

A driver can be contacted via phone subsequent to a ride to turn a temporary membership into permanent by going through full application process. In some embodiments, the system can support membership through linked accounts to corporations or families. For example, all transactions are recorded separately (e.g., for tax or expense purposes). A member can have more than one membership card. Funding for such a card can either come from a linked account (i.e., company pays directly) or from the member's main account.

In some embodiments, GTVPS can use published rates for foreign currency transactions. A membership account may be held in the currency of the member's residency. In some embodiments, a membership level is provided. Membership levels could, for example, be classic, bronze, silver, and gold. To reach a membership level, the criteria can include, for example, length of history with the system, a number of transactions, auto-recharge level on account, auto-reservation on member's credit card, and/or member rating.

In some embodiments, shared rides can be taxed. If taxability is relevant in a country/state where GTVPS operates, then GTVPS may provide an annual report to members to show the ‘money’ earned or ‘paid’. Reports can be provided electronically. In some embodiments, the system provides for fraud protection. Various measures can be taken to harden GTVPS against fraud. For example, an automatic fare calculator can contain a sense check to identify fraudulent data (e.g. trip of 1 mile for $1,000). For example, the system can provide for a delayed account discharge, which means only transactions older than <x> days can be included into manual account discharge request. This can allow a passenger to report fraudulent transactions. For example, the system can include a named user concept, which leads to a lifetime history (e.g., one/two/or three strikes and you are out). This is comparable with the concept of credit history in the U.S.

### Ride Request Fulfillment Optimizer (RRFO)

Passengers use a ride share system to go to their daytime location while assuming that they have a reasonable option to go home. However, not every return trip request from the daytime location to the ‘remote’ home can be matched to a driver's offer. Third parties (e.g., taxi services, van services, and bus services) can be utilized to service these requests. To keep transport costs for individual users at levels that comply with the idea of ride share concepts, ride requests from several users can be combined into one transport request, which then can be published to and accepted by a driver such as another member or a subscribing 3rd party service providers.

In general, the RRFO system combines one or several ride requests into one transportation schedule and present transportation schedule to transportation service providers. The transportation providers can then bid on the transportation schedule. In some examples, a transportation schedule can be comprised of a series of pick-up locations (e.g., a minimum of one) with a number of passengers (e.g., a minimum of one) to be picked up and earliest departure time for each pick-up location. In some embodiments, a transportation schedule can be comprised of a series of drop-off locations (e.g., a minimum of one) with number of passengers (e.g., a minimum of one) to be dropped off. In some embodiments, the transportation schedule can include general route information.

In some embodiments, the system includes a bidding manager application to allow the drivers or transportation service providers to bid on a transportation schedule. Bidding manager application chooses automatically the best fitting bid based on configurable criteria such as price, rating of transportation service provider, availability. The system communicates with all parties (e.g., passengers and drivers or transportation service providers) in handshake mode to confirm a determined transportation schedule. In some embodiments parties are allowed to agree on a no-show penalty.

Ride requesters (passengers) define a lead time with their ride request (e.g. 2 hours before a requested ride) at which an unfulfilled request can be processed by RRFO. RRFO can establish parties of passengers to be serviced by third parties (with pickup time, pickup location, drop-off location). RRFO can handle communication with all parties involved (riders and 3rd parties). RRFO may transfer the transportation schedule to 3rd parties that accepted the request (with pickup time, pickup location, number of passengers, drop-off location).

RRFO can be implemented in universal transportation systems. In some embodiments, RRFO can provide a component to complement existing ride share system worldwide. Software can be licensed out to ride share system operators/providers. Software for van/limo/bus operators that offer pooled rides (e.g. airport servicing companies) can be provided. The software can be licensed out to these service providers. RRFO can include small operators of airplanes for point-to-point transport. RRFO can include freight coordination (e.g., match left over space with one-off requests).

To distribute RRFO, the system can be licensed out to other ride share portal providers and to transportation providers which offer pooled rides. In some embodiments, RRFO operates as an electronic market place (e.g. for flights and freight). Advantageously, RRFO opens ride sharing to a much wider community by offering very reasonable fall back options (e.g., a no-rider-left-behind pact). A ride sharing portal that can make use of RRFO has a big competitive advantage in the market.

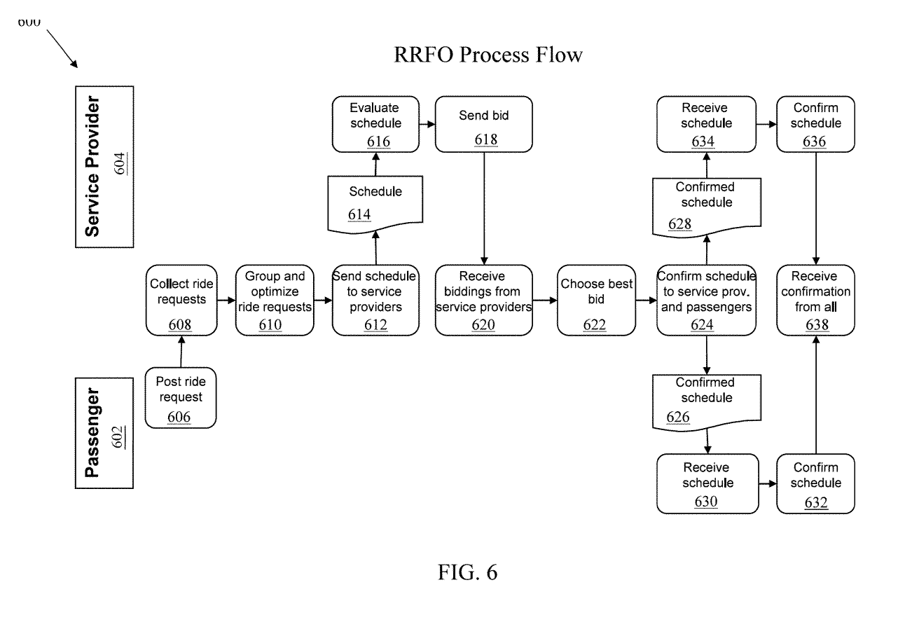

FIG. 6 depicts an exemplary flow chart illustrating a ride request fulfillment optimizer process flow 600 as executed on a computer system in some embodiments. The process flow 600 includes a passenger 602 and a service provider 604. The passenger posts 606 a ride request. For example, the passenger 602 navigates to or logs into a web-based client to post a ride request for 5:00 p.m. that evening. RRFO collects 608 ride requests. RRFO groups and optimizes 610 ride requests from a plurality of passengers. RRFO sends 612 a schedule 614 to service providers. The service provider 604 evaluates 616 the schedule. The service provider sends 618 a bid to RRFO. RRFO receives 622 bids from all bidding service providers. RRFO selects 622 the best bid from the group of received bids relating to the posted ride request. RRFO confirms 624 the schedule with both the service provider 604 and the passenger 602 by sending a confirmed schedule (626 and 628 for the passenger 602 and service provider 604, respectively). The passenger 602 receives 630 the confirmed schedule. The passenger 602 confirms 632 the schedule. The service provider 604 receives 634 the schedule. The service provider 604 confirms 636 the schedule. RRFO receives 638 confirmation from both the service provider 604 and the passenger 602.

For example, a passenger posts a ride request for 5:00 p.m. from their office in Boston, Mass. to their home in Charlestown, Mass. RRFO receives the ride request and groups it with any other similar ride requests based on, for example, the departure time, departure location, and arrival destination. After generating the grouped schedule, RRFO transmits the schedule to all participating service providers (e.g., driver members, taxis, limo services, and/or the like). Each participating service provider can then submit a bid for the schedule. For example, assume a taxi company submits a bid for the trip at $15.00 with a pick-up at 5:10. RRFO receives all of the bids from the respective service providers, and chooses the best bid (e.g., based on bid price, pick-up time, and/or the like). Once the service provider is established, it must be confirmed with both the service provider and the passenger. Upon confirmation by both parties, the trip is scheduled by RRFO.

In some embodiments, the system includes a request database with a web front-end. Open requests can be managed in the request database. In some embodiments, RRFO includes a provider database with a web front-end. Subscribed providers can be registered in the provider database.

In some embodiments, the system includes an optimizer. The optimizer can be, for example, a software module that includes instructions being operable to cause categorization and group open requests based on information such as from-location, to-location, requested time frame of pick-up, available transportation providers and their offers, price levels, rating of providers, and/or other criteria.

In some embodiments, the system includes a communication manager. The communication manager can be, for example, a software module that includes instructions that \ can cause communication with requesters and transportation providers. Communication to parties can be done via XML, email, SMS, voicemail, and other communication mediums.

In some embodiments, the system includes a bidding manager. The bidding manager can be, for example, a software module that includes instructions that can facilitate transportation providers' bidding for posted transportation requests (similar to, for example, Ebay/Priceline). In some embodiments, the system includes a web application in communication with a database.

Some exemplary embodiments can include, for example, a website, a request database (e.g., a database and web front-end), a transportation service provider ‘TSP’ database (e.g., a database and a web front-end), a communication manager application (e.g., via XML), a bidding manager core application, and/or a smart phone or iphone. Components can include servers, desktops, laptops, and/or a variety of software. Some exemplary functions can include, for example, entering requests, TSPs can post their services, optimizer functionality, XML communication with requesters and TSPs including handshake confirmation, and/or core bidding functionality. In some embodiments, “handshake confirmation” is considered a binding contractual agreement and a no show on the part of a party would incur a penalty.

By way of an example, the following is an exemplary case study for Mr. A. Mr. A's office is in a metro area, (e.g., at Kendall Square in Cambridge, Mass.). Mr. A works for an international company and travels frequently to various cities across the world for business. He lives in the suburbs, let's say in Lexington, which is a 15 mile commute to his office.

On Monday morning at 7:30 am, a person from his neighborhood, Mr. Driver, who works close to Mr. A's office gives Mr. A a ride into Cambridge, Kendall Square. He drops him off one block away from Mr. A's office. Mr. Driver calls an automated system when picking up and dropping off Mr. A., typing in Mr. A's membership number, which shows on his X-Ride card. The ride is 15 miles and Mr. Driver will receive 24 cents/mile from Mr. A through an automated payment.

Mr. A spends the day at the office and at 4 pm catches the subway to the Boston airport. This time he uses his company X-card to enter the subway station. Arriving in London the next morning, he takes the Heathrow Express train, which gets him into the city in 15 minutes. When entering the platform, he simply swipes his company X-card to get access.

The next day in Paris, Mr. A experiences a similar scenario when taking the Air France bus into town and the Metro to go to the Parisian company office. Coming back into Boston Logan airport, he uses his iphone to post a ride share request to his home, while the plane is still taxiing to the gate. While walking out of the gate area he receives a message that someone with an ‘AA’ rating is going back to Arlington center within the next 5 minutes. He confirms the offer and 2 minutes later his phone rings and an automated call initiated through X-Ride has connected Mr. A with his driver. They meet easily, the ride is pleasant and when dropping off Mr. A at the taxi stand in Arlington center it is this time Mr. A who makes the call to report the end of the ride. Again the driver will receive 24 cents/mile plus half the tunnel toll automatically from the company card.

Back in the office the next day (this time ride sharing with another person), Mr. A does not have to file an expense report. The team assistant has subscribed to the monthly report from his company X-card, which she will receive via email. His company X-card has a monthly budget of $800 and a retainer of $80 is maintained on the related X-account through an auto-recharge mode against a company credit card. In case that the monthly budget might not be sufficient, Mr. A's boss will receive an email to authorize an excess budget or to increase the regular budget.

This time Mr. A has to stay long hours in the office. At 6 pm no available ride share offer had been found to match his request for a ride to Lexington leaving Kendall Square between 8-8:30 pm. That is the trigger for X-Ride to bundle unfulfilled ride requests and give them to transportation service providers which can bid on them. At 7 pm Mr. A receives a message that he can jump on a ride with a professional service leaving Kendall Square at 8:10 pm. He confirms. At 8 pm he leaves the office and walks 2 blocks to the pick-up point where 2 other passengers arrive with him. At 8:10 pm a small bus arrives. All passengers swipe their Xcard when entering (and later leaving) the bus. Four other passengers are on the bus from a pick-up at Boston's MGH. This time Mr. A will be charged 48 cents/mile.

Advantageously, the system can include many benefits. For example, Mr. A can benefit financially when ride sharing into work and back. Mr. A can benefit when entering public transport systems worldwide, as he does not need to figure out the fare systems before riding (single ride, day ticket, zones, student, etc.). Mr. A's company can benefit which needs to subsidize less employee parking due to an efficient and reliable ride share system. Mr. A's company can benefit because it needs much less time when dealing with employees' expenses. The public transport systems can benefit, as they need to maintain less ticket vending points. Passengers have no chance any more to cheat the system as riders pass entrance and exit swipe points. Mr. A's drivers benefit financially. Using the system avoids city parking space providers, car companies (less total mileage due to higher average load factor), and excessive gas usage.

### The System

The system can support a number of applications. In some embodiments, the system includes a Global Transportation and Payment Card System for public transport (GTVPS/pt). In some embodiments, the system includes a Global Transportation and Payment Card System for ride sharing (GTVPS/rs). GTVPS can be used in, for example, public transport and/or hitch hiking. In some embodiments, the system includes a Ride Request Fulfillment Optimizer (RRFO). In some embodiments, the system includes a Ride Share Portal (RSP). The RSP can include a route manager and/or a request manager. In some embodiments, the system includes a Ride Share Auto Match Maker (RSAMM). The backend system can automatically determine matches between ride requests and ride offers.

In some embodiments, the applications can be set up and run independently. In some embodiments, the system provides a global public transportation payment card. This can be, for example, a component of GTVPS. The core can be a membership card that works as a universal access card to public transport worldwide. Each ride can be recorded. Payments can be done automatically between accounts of passenger and service provider. Some exemplary paid services include a transaction processing fee for completed trip, an auto-recharge processing fee, and/or a provision of account statements for printing.

In some embodiments, the system provides a ride-share backend system. The backend system can be, for example, components of GTVPS and RRFO. This system can be based on the same membership card but adds a more extensive vetting level. It allows to record shared rides, to automatically calculate ‘fares’ and execute payments from passenger to driver. It also integrates professional transportation service providers to maximize passengers' flexibility. Some potential paid services include vetting applicants (e.g., criminal background, driving record), transaction processing fee for completed trip, an auto-recharge processing fee, an auto-discharge processing fee, and/or a provision of account statements for printing.

In some embodiments, the system provides for a global ride-share portal. The system can be components of GTVPS/rs, RRFO, RSP, and RSAMM. This portal can be a state-of-the-art full ride-share solution to allow users to post ride requests and ride offers. It entails use of automatic location determination, provides automatic matching features etc. As backbone it uses the ride-share backend system described above. Some potential paid services include, for example, vetting applicants, a matching fee for establishing a ride-share party, a transaction processing fee for completed trip, an auto-recharge processing fee, an auto-discharge processing fee, and/or a provision of account statements for printing.

In some embodiments, the system provide for a hitch hike vetting and payment card. The card can be implemented, for example, as a component of GTVSP/rs. This system can be based on the ride-share membership card (for vetted members). It allows to record shared rides, to automatically calculate ‘fares’ and execute payments from passenger to driver. Some exemplary paid services include vetting applicants, a transaction processing fee for completed trip, an auto-recharge processing fee, an auto-discharge processing fee, and/or a provision of account statements for printing.

In some embodiments, the system includes a global flight-share portal. The portal can be implemented as components of GTVPS/rs, RRFO, RSP, and RSAMM. This portal can be a state-of-the-art full flight-share solution to allow users to post flight requests and flight offers. It provides automatic matching features. As backbone it uses the ride-share backend system described above. Some exemplary paid services include vetting applicants, a matching fee for establishing a flight-share party, a transaction processing fee for completed trip, an auto-recharge processing fee, an auto-discharge processing fee, and a provision of account statements for printing. Some exemplary extensions can include cooperating with existing ride share providers in US and/or developing missing ride share components.

In some embodiments, the system includes penalties. For example, the system can include a no-show penalty. After a confirmed match, one of the parties might not show up. This leads to a penalty and will be recorded in the member's rating. For example, the system can include a cancellation penalty. After a confirmed match, one of the parties might cancel. This leads to a penalty. The penalty amount should depend on the remaining time until the confirmed start date/time. Penalties could be used, for example, to provide emergency alternate transportation. The system will try to find another match-partner. But in case of a short notice cancellation from a driver that would leave a passenger stranded, the system will try to arrange for transportation through transportation service partners. This could, for example, be done with a bidding mechanism (e.g., like eBay or Priceline). Payment can come from the passenger (who would pay a regular ride fare) and the system that would pay the difference (hopefully out of the accrued penalties). Penalty rates can be adjusted periodically based on the numbers.

In some embodiments, the system can provide carbon credits. For example, the service may be eligible to sell carbon credits depending on country specific legislation. Carbon credits should be awarded as kickback to members according to their actual use of the system.

In some embodiments, the match rate can be based on density of regional clusters of X-members. In some embodiments, the system provides for a ‘Win-a-friend’ program, where winning a friend as a member can be rewarded with points for free membership period or free rides, for example. Even a percentage of member fees could be reduced (e.g. <x> % of member's fees of first year). In some embodiments, the system can provide for a free membership for the first <n> members or first number of uses. To ‘hike’ a ride, members should flash their colored membership card to signal their demand. For example, it may be possible to establish specific stops for the system together w/bus stops, at highway service stops, and other common public transportation stops.

Advantageously, the system provides many benefits and advantages. For example, the system provides a cost benefit for members (e.g., lowering the cost of commuting). The system can provide a cost benefit for employers (e.g., reduction in parking). The system provides a convenience, since out of the high number of possible match partners, the system finds the best match so that meeting and drop-off points are as close to the match partners' locations/routes as possible. The system provides safety for ride share through the membership application procedures, which make sure that members meet certain criteria (vetting process). Transaction recording can make all rides transparent.

In some embodiments, the system can be focused on spontaneous match making, which can allow members to follow their own schedule. The system can also provide administrative support for car pools to keep them as clients. The convenience of payment handling through a system agent operates with no negotiations and/or handling of money. Payment can be guaranteed through member account system and system checks. In some embodiments, the member selection process and/or use of personal profile and rating system can make sure that people are matched who fit. For example, misbehaving people (e.g., people who fail to pay for realized services, people who fail to show up for pre-established pick-ups, etc.) can be sorted out of the system quickly and on a permanent basis. In some embodiments, the system provides hotline services.

Hotline services can complement the system and help with, for example, dealing with emergencies. For example, an “X-Agent” may staff a hotline to provide certain services. Services can be, for example, servicing a stranded member (e.g., “I am stuck in xyz and need a ride to such and such”). The stranded member service could be a payable service, where the X-Agent can look up public transport, connect to 3rd party service, and/or request a general cab service. Advantageously, a stranded member service can help mitigate a member's fear of getting stuck without a ride. In some embodiments, the hotline service can be done via automated services. For example, the phone system can recognize the phone number of the caller, looks up X-member-ID, uses GPS location from caller, and/or the like. The system can have local/regional service desks (e.g. for NY/BOS/etc. metropolitan area).

In some embodiments, the system provides solutions to restrictions that keep existing ride share providers in a niche. This means that X-Ride can open a much bigger market for the basic concept and has the potential to integrate all niches. The system has “one-size-fits-all” capabilities, because the core concept is so universal. This means that it can be implemented into the safest market segment first at relatively low cost and risk. Once established to some degree, it can be rolled out both horizontally (domestic/regional and international) as well as vertically (other market segments). The system can be extended in numerous ways. For example, in some embodiments, the system can be extended to support online advertising (e.g., cab services, phones, gadgets, holidays, etc.). The system can be extended to credit card, banking institutions, rental car companies and/or insurance companies. For example, such institutions may provide terms to members.

The above-described systems and methods can be implemented in digital electronic circuitry, in computer hardware, firmware, and/or software. The implementation can be as a computer program product (i.e., a computer program tangibly embodied in a tangible information carrier). The implementation can, for example, be in a machine-readable storage device, for execution by, or to control the operation of, data processing apparatus. The implementation can, for example, be a programmable processor, a computer, and/or multiple computers.

The computer program product can be written in any form of programming language, including compiled and/or interpreted languages, and the computer program can be deployed in any form, including as a stand-alone program or as a subroutine, element, and/or other unit suitable for use in a computing environment. The computer program product can be deployed to be executed on one computer or on multiple computers at one site.

Method steps can be performed by one or more programmable processors executing the computer program product to perform functions of the technology provided herein by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program product, the processor, the special circuitry, software, and/or hardware that implements that functionality.

Processors suitable for the execution of a computer program product include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magnetooptical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network).

The system can include clients and servers. A client and a server are generally remote from each other and typically interact through a communication network. The relationship of client and server arises by virtue of computer programs running on the respective computers and having a client-server relationship to each other.

Examples of communication networks include a packet-based network and/or a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth, code-division multiple access (CDMA) network, time division multiple access (TDMA) network, global system for mobile communications (GSM) network), and/or other circuit-based networks.

The client can be, for example, part of and/or implemented on a computing device. The computing device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

Comprise, include, and/or plural forms of each are open ended and include the listed parts and can include additional parts that are not listed. And/or is open ended and includes one or more of the listed parts and combinations of the listed parts.

One skilled in the art will realize the technology provided herein may be embodied in other specific forms without departing from the spirit or essential characteristics thereof. The foregoing embodiments are therefore to be considered in all respects illustrative rather than limiting of the technology described herein. Scope of the invention is thus indicated by the appended claims, rather than by the foregoing description, and all changes that come within the meaning and range of equivalency of the claims are therefore intended to be embraced therein.

While the technology has been particularly shown and described with reference to specific illustrative embodiments, it should be understood that various changes in form and detail may be made without departing from the spirit and scope of the technology.

1. A computerized method for generating a transportation schedule comprising: receiving one or more ride requests; generating the transportation schedule based on the one or more ride requests, wherein for each passenger associated with each of the one or more ride requests, the transportation schedule comprises one or more of a pick-up location, a pick-up departure time, a drop-off location, and route information; transmitting the transportation schedule to one or more transportation service providers; receiving a bid from each of the one or more transportation service providers; and selecting a transportation service provider for the transportation schedule based on the bids.

2. The computerized method of claim 1 further comprising: confirming the transportation schedule with each passenger associated with the one or more ride requests and confirming the transportation schedule with the transportation service provider for the transportation schedule.

3. The computerized method of claim 1 further comprising automatically calculating a best fitting bid for a transportation service provider from the one or more transportation service providers based on one or more bidding criteria.

4. The computerized method of claim 3, wherein the bidding criteria is one or more of price, rating, location, destination, type of transportation, and availability.

5. The computerized method of claim 1 further comprising categorizing the one or more ride requests.

6-11. (canceled)

12. A computerized method for providing a global transportation vetting and payment system, the method comprising vetting a member, storing vetted information in a subscriber database, storing a trip detail, wherein the trip detail is based on a trip performed by a transportation provider, calculating a cost based on the trip information, and automatically transmitting a payment for the cost.

13. The computerized method of claim 12, further comprising verifying a status of the member in real time.

14. The computerized method of claim 13, wherein verifying comprises assessing one or more attributes of the member.

15. The computerized method of claim 14, wherein the one or more attributes are selected from the group consisting of account status, vetting status, account balance, and member rating.

16. The computerized method of claim 15, wherein the member rating is an automatic member rating.

17. The computerized method of claim 16, further comprising automatically calculating the member rating based on a number of trips, a ratio of complaints, or both.

18. The computerized method of claim 12, wherein calculating comprises automatically calculating the cost based on a trip distance or a trip duration.

19. The computerized method of claim 12, wherein calculating comprises calculating a load factor, wherein the load factor is based on a number of passengers associated with the trip.

20. (canceled)

21. The computerized method of claim 20, wherein the trip detail further comprises a driver membership number, a passenger membership number, and leg information for each leg of one or more legs of the trip.

22. The computerized method of claim 21, wherein the leg information comprises a load factor, a location information, a time information, and a distance information.

23. The computerized method of claim 22, wherein the location information comprises a start point and an end point, and the time information comprises a start time and an end time.

24. The computerized method of claim 12 further comprising either performing an auto-recharge of a member account, performing an auto-discharge of the member account, or both.

25. (canceled)

26. The computerized method of claim 12, wherein the transportation provider is a public transportation system, a commercial transportation system, or a ride share transportation system.

27-33. (canceled)

34. A computer program product for generating a transportation schedule, tangibly embodied in an information carrier, the computer program product including instructions being operable to cause a data processing apparatus to receive one or more ride requests, generate the transportation schedule based on the one or more ride requests, wherein for each passenger associated with each of the one or more ride requests, the transportation schedule comprises one or more of a pick-up location, a pick-up departure time, a drop-off location, and route information,
transmit the transportation schedule to one or more transportation service providers, receive a bid from each of the one or more transportation service providers, and select a transportation service provider for the transportation schedule based on the bids.

35. (canceled)

36. A computer program product for providing a global transportation vetting and payment system, tangibly embodied in an information carrier, the computer program product including instructions being operable to cause a data processing apparatus to vet a member, wherein vetted information is stored in a subscriber database, store a trip detail, wherein the trip detail is based on a trip performed by a transportation provider, wherein the transportation provider is a public transportation system, a commercial transportation system, or a ride share transportation system, calculate a cost based on the trip information, and automatically transmit a payment for the cost.
